(19) United States
(12) Patent Application Publication
(10) Pub. No.: US 2024/0142898 A1
(43) Pub. Date: May 2, 2024

(54) IMAGE FORMING DEVICE

(71) Applicant: SHARP KABUSHIKI KAISHA, Osaka (JP)

(72) Inventors: YOSHIHIRO YOSHIKAWA, Osaka (JP); Hideshi IZUMI, Sakai City, Osaka (JP)

(73) Assignee: SHARP KABUSHIKI KAISHA, Osaka (JP)

(21) Appl. No.: 18/381,827

(22) Filed: Oct. 19, 2023

(30) Foreign Application Priority Data
Nov. 2, 2022 (JP) 2022-175905

(51) Int. Cl. G03G 15/16

(52) U.S. Cl. CPC G03G 15/1615

(57) ABSTRACT

An image forming device includes one or more image carriers on which a toner image is formed; a transfer belt that transfers a toner image formed on the image carrier; a presser that presses the transfer belt against the image carrier to transfer the toner image onto the transfer belt; and a switching mechanism that switches a position of the presser according to a rotation angle of a cam. The switching mechanism switches a position of the presser to one of a first position that presses the transfer belt against the image carrier, a second position that is separated from the image carrier, and a third position that is a position separated from the image carrier and having a smaller separation distance from the image carrier than the second position.

### CROSS-REFERENCE TO RELATED APPLICATION

The present application claims priority from Japanese Application JP2022-175905, filed on Nov. 2, 2022, the content of which is hereby incorporated by reference into this application.

### BACKGROUND OF THE INVENTION

### 1. Field of the Invention

The present disclosure relates to an image forming device.

### 2. Description of the Related Art

As a conventional technique, proposed is an image forming device including a transfer device that transfers a toner image from an image carrier to a paper sheet via an intermediate transfer belt.

In the image forming device disclosed in the conventional technique, the transfer device is provided with a transfer roller that can be displaced in a direction that makes contact with, and separates from, the image carrier.

### SUMMARY OF THE INVENTION

However, when a presser (transfer roller) in a position that is separated from the image carrier moves to a position that presses the image carrier, and then presses the image carrier, a large impact sound is generated between the presser and the image carrier.

An object of the present disclosure is to provide an image forming device that enables an impact sound generated when an image carrier is pressed by a presser to be suppressed.

An image forming device according to an aspect of the present disclosure includes: one or more image carriers on which a toner image is formed; a transfer belt that transfers a toner image formed on the image carrier; a presser that presses the transfer belt against the image carrier to transfer the toner image onto the transfer belt; and a switching mechanism that switches a position of the presser according to a rotation angle of a cam; wherein the switching mechanism switches a position of the presser to one of a first position that presses the transfer belt against the image carrier, a second position that is separated from the image carrier, and a third position that is a position separated from the image carrier and having a smaller separation distance from the image carrier than the second position.

According to an aspect of the present disclosure, an image forming device is capable of suppressing an impact sound generated when an image carrier is pressed by a presser.

### BRIEF DESCRIPTION OF THE DRAWINGS

FIG. 1 is a schematic diagram showing an example of an internal structure of an image forming device according to an embodiment of the present disclosure.

FIG. 2 is a diagram schematically showing an example of a configuration when all of the intermediate transfer rollers provided in an intermediate transfer belt unit according to the embodiment of the present disclosure are in a separated position.

FIG. 3 is a diagram schematically showing an example of a configuration when the intermediate transfer rollers provided in the intermediate transfer belt unit according to the embodiment of the present disclosure are in a pressing position and a retracted position.

FIG. 4 is a diagram schematically showing an example of a configuration when all of the intermediate transfer rollers provided in the intermediate transfer belt unit according to the embodiment of the present disclosure are in the pressing position.

FIG. 5 is a diagram schematically showing an example of a configuration when all of the intermediate transfer rollers provided in the intermediate transfer belt unit according to the embodiment of the present disclosure are in the retracted position.

FIG. 6 is a plan view of the intermediate transfer belt unit shown in FIG. 2.

FIG. 7 is a schematic diagram showing an example of the main components of a first swing member included in the intermediate transfer belt unit according to the embodiment of the present disclosure.

FIG. 8 is a schematic diagram showing an example of the main components of a first swing member included in the intermediate transfer belt unit according to the embodiment of the present disclosure.

FIG. 9 is a diagram showing an example of the configuration of a cam included in the intermediate transfer belt unit according to the embodiment of the present disclosure.

FIG. 10 is a diagram showing an example of a first cam of the cam shown in FIG. 9.

FIG. 11 is a diagram showing an example of a second cam of the cam shown in FIG. 9.

FIG. 12 is a table showing a correspondence relationship between the rotation angle of the cam included in the intermediate transfer belt unit according to the embodiment of the present disclosure, the operation state of the image forming device, the position of a first intermediate transfer roller, and the position of a second intermediate transfer roller to fourth intermediate transfer roller.

FIG. 13 is a diagram showing an example of a cam included in an intermediate transfer belt unit according to a modification of the embodiment of the present disclosure.

FIG. 14 is a table showing a correspondence relationship between the rotation angle of the cam included in the intermediate transfer belt unit according to the modification of the embodiment of the present disclosure, the operation state of the image forming device, the position of a first intermediate transfer roller, and the position of a second intermediate transfer roller to fourth intermediate transfer roller.

### DETAILED DESCRIPTION OF THE INVENTION

Hereinafter, an embodiment and modification of the present disclosure will be described with reference to the accompanying drawings. The same reference numerals are given below to the same or equivalent components throughout all the drawings, and duplicate descriptions are omitted. The embodiment and modification described below are merely examples of the present disclosure, and the present disclosure is not limited to the embodiment and modification. In addition to the embodiment and modification, various changes may be made according to the design and the like without departing from the technical concept of the present disclosure.

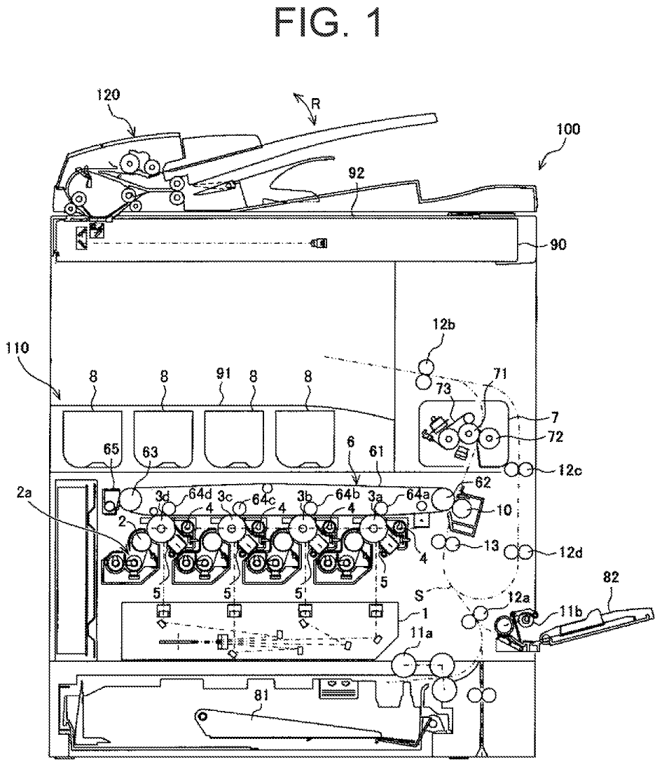

An image forming device 100 according to the embodiment of the present disclosure will be described with reference to FIG. 1. FIG. 1 is a schematic diagram showing an example of an internal structure of an image forming device 100 according to the embodiment of the present disclosure. FIG. 1 is a diagram of the internal structure of the image forming device 100 when viewed from the front side. Note that, in the image forming device 100, of the horizontal directions when viewed from the front side, the left side is defined as the left direction, and the right side is defined as the right direction. Furthermore, of the depth directions when viewed from the front side, the front side (near side) of the image forming device 100 is defined as the front direction, and the rear side (far side) is defined as the rear direction. Moreover, in the image forming device 100, the bottom side is defined as the downward direction, and the opposite side is defined as the upward direction.

The image forming device 100 is a laser color printer that forms multicolor and monochrome images on a paper sheet on which an image is formed. The image forming device 100 prints an image on a paper sheet based on image data read from a document by an image reading device 90, or image data received from an external source. Note that, although a laser color printer is described as an example of the image forming device 100 in the present embodiment, the present disclosure is not limited to this.

As shown in FIG. 1, the image forming device 100 includes a printer 110, an image reading device 90, a document table 92, and an automatic document processing device 120. The printer 110 includes an exposure unit 1, developers 2, photoreceptor drums 3a to 3d (image carriers), cleaner units 4, chargers 5, an intermediate transfer belt unit 6, a fusing unit 7, a paper feeding cassette 81, and a manual paper feeding cassette 82. The photoreceptor drums 3a to 3d are simply referred to as the photoreceptor drums 3 when there is no need for the description to distinguish between them.

The upper part of the printer 110 is provided with the image reading device 90 and the document table 92, which is made of transparent glass. Furthermore, the automatic document processing device 120 is installed on the upper side of the document table 92.

The automatic document processing device 120 automatically transports a document onto the document table 92. Moreover, the automatic document processing device 120 is configured so as to be rotatable in the direction of arrow R. Further, a document can be placed on the document table 92 by opening the top of the document table 92.

The image reading device 90 reads image data from a document transported or placed on the document table 92. The printer 110 prints an image on a paper sheet based on the image data read by the image reading device 90.

The image data handled by the image forming device 100 corresponds to a color image that uses each of cyan (C), magenta (M), yellow (Y), and black (K) colors. Accordingly, the developers 2, the photoreceptor drums 3, the cleaner units 4, and the chargers 5 are each provided so as to form four types of latent images corresponding to the respective colors.

The chargers 5 uniformly charge the surfaces of the photoreceptor drums 3 to a predetermined potential. The chargers 5 may be charger type, contact type, or brush type chargers or the like.

The exposure unit 1 is configured as a laser scanning unit (LSU) provided with a laser emitter, a reflecting mirror, and the like. The exposure unit 1 includes polygon mirrors for performing scanning with a laser beam, and optical components, such as lenses or mirrors, for guiding the laser beam reflected by the polygon mirrors to the photoreceptor drums 3. The exposure unit 1 exposes the charged photoreceptor drums 3 according to the image data to form electrostatic latent images corresponding to the image data on the surfaces of the photoreceptor drums 3.

The developers 2 visualize the electrostatic latent images formed on the photoreceptor drums 3 using toner. The toner images are formed on the photoreceptor drums 3 as a result of being visualized with toner. The developers 2 include developer tanks 2a, and the toner is accommodated in the developer tanks 2a. The developers 2 are configured to supply the toner accommodated in the developer tanks 2a to the photoreceptor drums 3. Furthermore, the developer tanks 2a are connected to toner cartridges 8 that accommodate the toner via toner supply pipes (not shown). The toner cartridges 8 are provided for each of the four toner colors.

The cleaner units 4 remove and collect the residual toner remaining on the surfaces of the photoreceptor drums 3 after development and image transfer.

The intermediate transfer belt unit 6 is disposed above the photoreceptor drums 3. The intermediate transfer belt unit 6 includes an intermediate transfer belt 61 (transfer belt), an intermediate transfer belt drive roller 62, an intermediate transfer belt driven roller 63, a first intermediate transfer roller 64a to fourth intermediate transfer roller 64d (pressers), and an intermediate transfer belt cleaning unit 65. The first intermediate transfer roller 64a to fourth intermediate transfer roller 64d are provided corresponding to the respective colors of K, Y, M, and C. Note that the first intermediate transfer roller 64a to fourth intermediate transfer roller 64d are simply referred to as the intermediate transfer rollers 64 when there is no need for the description to distinguish between them.

The intermediate transfer belt drive roller 62, the intermediate transfer belt driven roller 63, and the first intermediate transfer roller 64a to fourth intermediate transfer roller 64d each stretch and rotationally drive the intermediate transfer belt 61.

The intermediate transfer rollers 64 apply a transfer bias for transferring the toner images of the photoreceptor drums 3 onto the intermediate transfer belt 61, and also press the photoreceptor drums 3. The position in which the intermediate transfer rollers 64 press the photoreceptor drums 3 via the intermediate transfer belt 61 is referred to as the pressing position (first position).

Furthermore, although not illustrated in FIG. 1, in the image forming device 100, the intermediate transfer belt unit 6 further includes a movement mechanism 20 (switching mechanism) that enables the intermediate transfer rollers 64 to move so as to make contact with, and separate from, the photoreceptor drums 3. The movement mechanism 20 provided in the intermediate transfer belt unit 6 will be described in detail later.

The intermediate transfer belt 61 is provided so as to make contact with each of the photoreceptor drums 3. Further, the toner images of each color formed on the photoreceptor drums 3 are successively superimposed and transferred onto the intermediate transfer belt 61. As a result, a color toner image (multicolor toner image) is formed on the intermediate transfer belt 61. The intermediate transfer belt 61 is formed having an endless shape using a film having a thickness of, for example, approximately 100 μm to 150 μm.

The transfer of the toner images from the photoreceptor drums 3 to the intermediate transfer belt 61 is performed by the intermediate transfer rollers 64 which are in contact with the rear side of the intermediate transfer belt 61. A high-voltage transfer bias (a high voltage having the opposite polarity (+) to the charge polarity of the toner (−)) for transferring the toner images is applied to the intermediate transfer rollers 64. The intermediate transfer rollers 64 are rollers formed based on a metal (for example, stainless steel) shaft with a diameter of 8 mm to 10 mm, and the surfaces are covered with a conductive elastic material (such as EPDM or urethane foam). The conductive elastic material enables a high voltage to be uniformly applied to the intermediate transfer belt 61.

The electrostatic latent images visualized on the photoreceptor drums 3 corresponding to each hue are stacked on the intermediate transfer belt 61, and then transferred onto a paper sheet by a transfer roller 10 disposed in a contact position between the paper sheet and the intermediate transfer belt 61.

At this time, the intermediate transfer belt 61 and the transfer roller 10 are pressed against each other at a predetermined nip. Further, a voltage is applied to the transfer roller 10 in order to transfer the toner to the paper sheet (a high voltage having the opposite polarity (+) to the charge polarity of the toner (−)).

Moreover, as described above, the toner attached to the intermediate transfer belt 61 as a result of making contact with the photoreceptor drums 3 or the toner remaining on the intermediate transfer belt 61 due to transfer not being performed onto the paper sheet by the transfer roller 10, is removed and collected by the intermediate transfer belt cleaning unit 65 since such toner causes mixing of the toner colors in the subsequent step.

The intermediate transfer belt cleaning unit 65 includes, for example, a cleaning blade serving as a cleaning member that makes contact with the intermediate transfer belt 61. The surface of the intermediate transfer belt 61 on the opposite side to the surface that makes contact with the cleaning blade is supported by the intermediate transfer belt driven roller 63.

The paper feeding cassette 81 is a tray for storing paper sheets to be used in image formation, and is provided on the lower side of the exposure unit 1 of the printer 110. Furthermore, the manual paper feeding cassette 82 is provided on a side surface of the printer 110. In the image forming device 100, paper sheets can also be manually set in the manual paper feeding cassette 82.

The printer 110 further includes a paper discharge tray 91. The paper discharge tray 91 accumulates printed paper sheets in a face-down manner.

Furthermore, the printer 110 is provided with a sheet transport path S for transporting the paper sheets in the paper feeding cassette 81 and the manual paper feeding cassette 82 to the paper discharge tray 91 via the transfer roller 10 and the fusing unit 7. Pickup rollers 11a and 11b, a plurality of transport rollers 12a to 12d, a registration roller 13, the transfer roller 10, the fusing unit 7, and the like are disposed along the sheet transport path S from the paper feeding cassette 81 or the manual paper feeding cassette 82 to the paper discharge tray 91.

The transport rollers 12a to 12d are small rollers for assisting the transport of the paper sheets, and are disposed along the sheet transport path S. The pickup roller 11a is disposed in the vicinity of an end of the paper feeding cassette 81, picks up the paper sheets one by one from the paper feeding cassette 81, and supplies the paper sheets to the sheet transport path S. Similarly, the pickup roller 11b is disposed in the vicinity of an end of the manual paper feeding cassette 82, picks up the paper sheets one by one from the manual paper feeding cassette 82, and supplies the paper sheets to the sheet transport path S.

The registration roller 13 temporarily holds a paper sheet being transported in the sheet transport path S. The registration roller 13 transports a paper sheet to the transfer roller 10 at a timing when a leading edge of the toner image on the intermediate transfer belt 61 is aligned with the leading edge of the paper sheet.

The fusing unit 7 includes a heat roller 71 and a pressure roller 72. The heat roller 71 and the pressure roller 72 rotate with a paper sheet held between them. Furthermore, the heat roller 71 is set to a predetermined fusing temperature based on a signal from a temperature detector (not shown). Then, the heat roller 71, together with the pressure roller 72, thermally compresses the toner onto the paper sheet. As a result, the fusing unit 7 can melt, mix, and press the multicolor toner image that has been transferred onto the paper sheet, and thermally fuse the toner image onto the paper sheet. The fusing unit 7 includes an external heating belt 73 for externally heating the heat roller 71.

Movement Mechanism

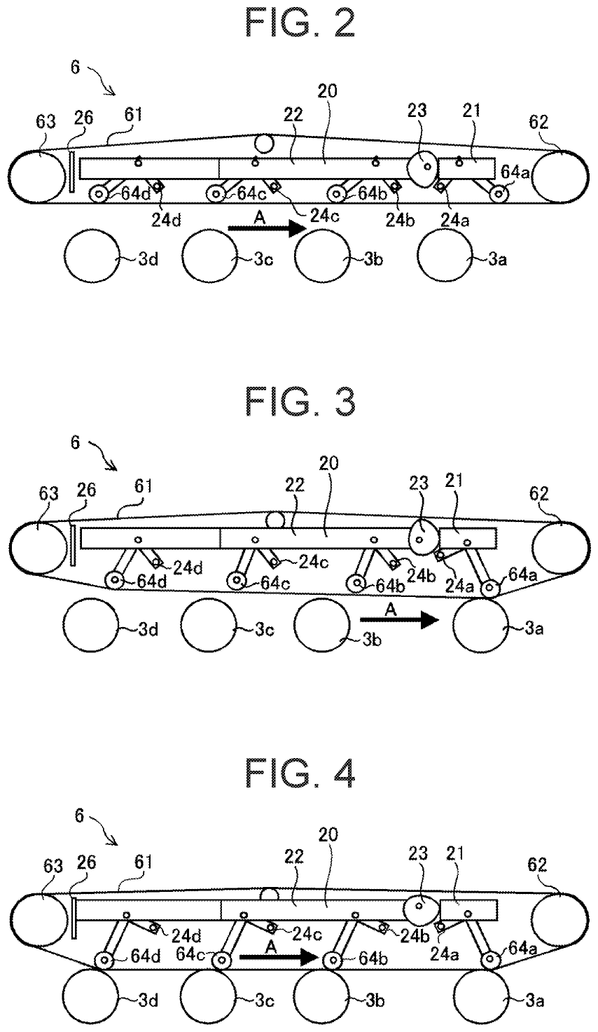

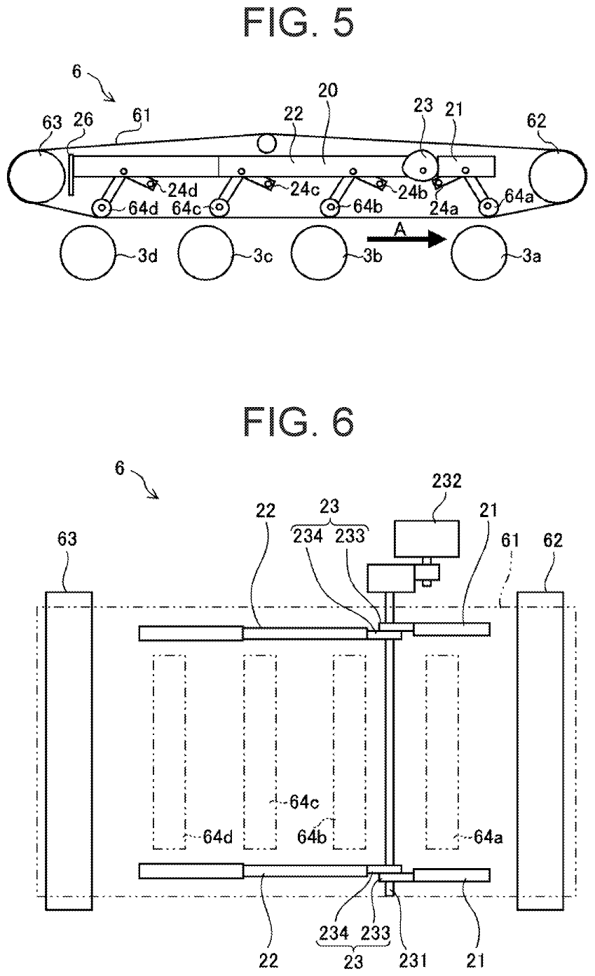

Next, a configuration of the movement mechanism 20 provided in the intermediate transfer belt unit 6 will be described with reference to FIGS. 2 to 5. FIG. 2 is a diagram schematically showing an example of a configuration when all of the intermediate transfer rollers 64 provided in the intermediate transfer belt unit 6 according to the embodiment of the present disclosure are in a separated position (second position). FIG. 3 is a diagram schematically showing an example of a configuration when the intermediate transfer rollers 64 provided in the intermediate transfer belt unit 6 according to the embodiment of the present disclosure are in a pressing position (first position) and a retracted position (third position). FIG. 4 is a diagram schematically showing an example of a configuration when all of the intermediate transfer rollers 64 provided in the intermediate transfer belt unit 6 according to the embodiment of the present disclosure are in the pressing position (first position). FIG. 5 is a diagram schematically showing an example of a configuration when all of the intermediate transfer rollers 64 provided in the intermediate transfer belt unit 6 according to the embodiment of the present disclosure are in the retracted position. FIGS. 2 to 5 are diagrams of the intermediate transfer belt unit 6 when viewed from the front side of the image forming device 100.

As shown in FIGS. 2 to 5, the intermediate transfer belt 61 is stretched between the intermediate transfer belt drive roller 62 and the intermediate transfer belt driven roller 63, and forms a predetermined loop-shaped movement path. The photoreceptor drum 3a, the photoreceptor drum 3b, the photoreceptor drum 3c, and the photoreceptor drum 3d are disposed on the outer peripheral surface side of the intermediate transfer belt 61 in this order from the downstream side of the movement direction A of the intermediate transfer belt 61. The first intermediate transfer roller 64a to fourth intermediate transfer roller 64d are disposed in positions facing the photoreceptor drums 3a to 3d with the intermediate transfer belt 61 held therebetween. In the present embodiment, the intermediate transfer belt 61 is disposed between the photoreceptor drums 3 and the intermediate transfer rollers 64 disposed above the photoreceptor drums 3.

The intermediate transfer rollers 64 are capable of moving due to the movement mechanism 20 so as to make contact with, and separate from, the respective opposing photoreceptor drums 3. Further, the movement mechanism 20 is configured so as to be capable of switching, according to the rotation angle of cams 23, the positions of the intermediate transfer rollers 64 to one of the pressing position (first position), in which the intermediate transfer belt 61 is pressed against the photoreceptor drums 3, the separated position (second position) which is separated from the photoreceptor drums 3, and the retracted position (third position), which is a position that is separated from the photoreceptor drums 3 but having a smaller separation distance from the photoreceptor drums 3 than the separated position.

The separated position is the position of the intermediate transfer rollers 64 when the intermediate transfer belt unit 6 is detached from the image forming device 100. When in the separated position, the intermediate transfer rollers 64 are in a position that is, for example, 5 mm away from the photoreceptor drums 3.

Furthermore, the pressing position is the position of the intermediate transfer rollers 64 when the toner image formed on the photoreceptor drums 3 is transferred to the intermediate transfer belt when printing is executed, and is a position in which the intermediate transfer rollers 64 press the photoreceptor drums 3 via the intermediate transfer belt 61. When color printing is executed, each of the first intermediate transfer roller 64a to fourth intermediate transfer roller 64d moves to a position that presses the corresponding photoreceptor drum 3a to photoreceptor drum 3d. However, when monochrome printing is performed, only the first intermediate transfer roller 64a that presses the photoreceptor drum 3a (first image carrier) corresponding to K moves to the pressing position, and the second intermediate transfer roller 64b to fourth intermediate transfer roller 64d move to the retracted position.

The retracted position is the position of the intermediate transfer rollers 64 when the image forming device 100 in print standby. When in the retracted position, the intermediate transfer rollers 64 are in a position that is, for example, in a near position that is 1 mm to 2 mm away from the photoreceptor drums 3. Note that print standby is a state where the image forming device 100 is waiting for a print execution instruction.

Specifically, in the intermediate transfer belt unit 6, when the intermediate transfer rollers 64 are in the separated position, for example, as shown in FIG. 2, each of the first intermediate transfer roller 64a to fourth intermediate transfer roller 64d are in a position that is sufficiently separated from the photoreceptor drum 3a to photoreceptor drum 3d. At this time, the intermediate transfer belt 61 is also in a position that is separated from each of the photoreceptor drum 3a to photoreceptor drum 3d.

Furthermore, at the time of monochrome printing, for example, as shown in FIG. 3, the first intermediate transfer roller 64a corresponding to K is disposed in the pressing position and causes the intermediate transfer belt 61 to make pressing contact with the photoreceptor drum 3a. On the other hand, the second intermediate transfer roller 64b to fourth intermediate transfer roller 64d for colors corresponding to each of Y, M, and C, are each disposed in the retracted position, which causes the intermediate transfer belt 61 to be separated from each of the photoreceptor drum 3b to photoreceptor drum 3d.

Moreover, at the time of color printing, for example, as shown in FIG. 4, each of the first intermediate transfer roller 64a to fourth intermediate transfer roller 64d are disposed in the pressing position, which causes the intermediate transfer belt 61 to make pressing contact with each of the photoreceptor drum 3a to photoreceptor drum 3d.

In addition, during print standby, for example, as shown in FIG. 5, each of the first intermediate transfer roller 64a to fourth intermediate transfer roller 64d are in a position that is separated from, but close to, each of the photoreceptor drum 3a to the photoreceptor drum 3d.

When the movement mechanism 20 sets the position of the intermediate transfer rollers 64 to the pressing position, the movement mechanism 20 moves the intermediate transfer rollers 64 that are in a state of being held in the retracted position to the pressing position. In other words, the movement mechanism 20 switches the intermediate transfer rollers 64 from a state of being held the retracted position to the pressing position. In this way, when the intermediate transfer rollers 64 are moved to the pressing position, the movement distance of the intermediate transfer rollers 64 can be reduced by controlling the intermediate transfer rollers 64 so as to move from the retracted position. Therefore, the impact noise generated when the photoreceptor drums 3 are pressed by the intermediate transfer rollers 64 can be suppressed.

Further, as described above, the movement of the first intermediate transfer roller 64a to fourth intermediate transfer roller 64d is performed by the movement mechanism 20. The configuration of the movement mechanism 20 will be described below.

The movement mechanism 20 includes first link members 21, second link members 22, cams 23, and a first swing member 24a to fourth swing member 24d.

The first link members 21 are members that are joined to the first swing member 24a provided with the first intermediate transfer roller 64a on a leading edge. Furthermore, the second link members 22 are members that are joined to the second swing member 24b to fourth swing member 24d each provided with the second intermediate transfer roller 64b to fourth intermediate transfer roller 64d on a leading edge.

As shown in FIG. 2, when the intermediate transfer belt unit 6 is viewed from the side, the first link member 21 and the second link member 22 are disposed so as to extend on the same straight line along the movement direction A of the intermediate transfer belt 61. The first link member 21 and the second link member 22 are provided so as to be capable of moving within a predetermined range along the movement direction A. Note that the cam 23 are disposed between the first link member 21 and the second link member 22.

The cams 23 are a flat cam having an asymmetric outline (outer peripheral shape). As shown in FIG. 6, the cams 23 include a first cam 233 that switches the position of the first intermediate transfer roller 64a, and a second cam 234 that switches the position of each of the second intermediate transfer roller 64b to fourth intermediate transfer roller 64d. FIG. 6 is a plan view of the intermediate transfer belt unit 6 shown in FIG. 2. The distance from the center of each of the first cam 233 and the second cam 234 to the outer periphery is not constant, and the outer peripheral shapes of the first cam 233 and the second cam 234 are different. The detailed configuration of the cams 23 will be described later.

Furthermore, as shown in FIG. 6, the first link members 21, the second link members 22, and the cams 23 are disposed are respectively disposed on the front side and the rear side of the image forming device 100 between the intermediate transfer belt drive roller 62 and the intermediate transfer belt driven roller 63.

The first intermediate transfer roller 64a is supported via the first swing member 24a between the first link member 21 disposed on the front side and the first link member 21 disposed on the rear side. On the other hand, the second intermediate transfer roller 64b to fourth intermediate transfer roller 64d are supported via each of the second swing member 24b to fourth swing member 24d between the second link member 22 disposed on the front side and the second link member 22 disposed on the rear side.

The cam 23 on the front side and the cam 23 on the rear side are fixed to a single cam shaft 231, and rotate in the same phase to each other around the cam shaft 231. The cam shaft 231 is rotated by power transmitted from a drive source 232. For example, a stepping motor is used as the drive source 232. The intermediate transfer belt unit 6 is configured so that the rotation angle of the cams 23 can be grasped from the rotation speed and rotation time of the cams 23.

Furthermore, as a result of the first cam 233 of the cams 23 rotating, the first link members 21 making pressing contact with the first cams 233 approach and separate from the cam shaft 231 according to the outer peripheral shape of the first cams 233. In this way, the first link members 21 move along the movement direction A according to the outer peripheral shape of the first cams 233.

Furthermore, as a result of the second cam 234 of the cams 23 rotating, the second link members 22 making pressing contact with the second cams 234 move along the movement direction A according to the outer peripheral shape of the second cams 234.

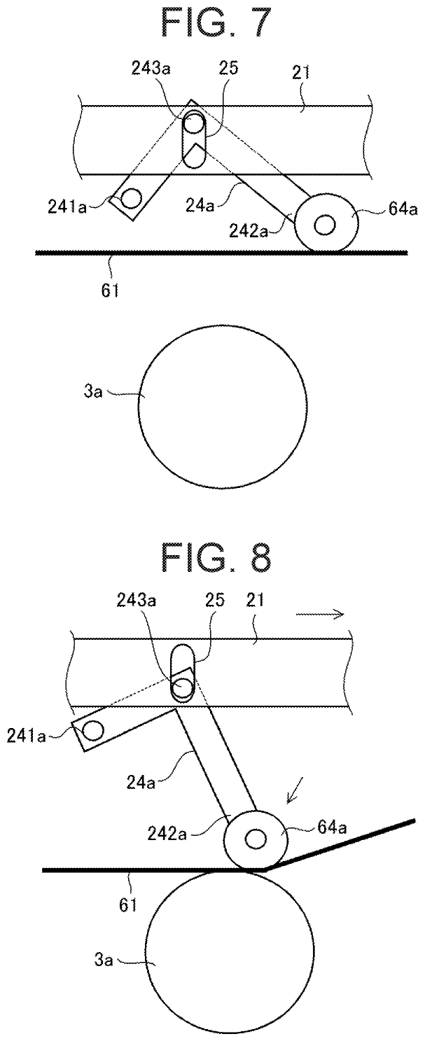

Here, the configuration of the first swing member 24a to fourth swing member 24d will be described in more detail with reference to FIGS. 7 and 8. Note that the first swing member 24a has the same configuration as the second swing member 24b to fourth swing member 24d except for a difference in installation direction. Further, for convenience of description, the first swing member 24a will be described as an example. FIGS. 7 and 8 are schematic diagrams showing an example of the main components of the first swing member 24a included in the intermediate transfer belt unit 6 according to the embodiment of the present disclosure. Note that the first swing member 24a, and the second swing member 24b to fourth swing member 24d are installed left-right symmetrically in FIG. 4.

As shown in FIGS. 7 and 8, the first swing member 24a has a shape which is bent in a letter-L shape. A first end 241a, which is one end of the first swing member 24a, is rotatably supported by a frame (not shown) of the intermediate transfer belt unit 6 in a position further on the photoreceptor drum 3a side than the first link member 21. A second end 242a, which is another end of the first swing member 24a, is rotatably supported by the first intermediate transfer roller 64a. Furthermore, the first swing member 24a is biased in a direction in which the first intermediate transfer roller 64a separates from the photoreceptor drum 3a, or in other words, toward the upper side, by an elastic member (not shown).

Moreover, as shown in FIGS. 7 and 8, the first link member 21 is provided with a slit 25, which is in a position facing the photoreceptor drum 3a, and extends in a direction that is orthogonal to the movement direction A in a side view.

The first swing member 24a has, on the bent portion, a projection 243a that protrudes in the rotation axis direction of the first intermediate transfer roller 64a. The projection 243a is capable of moving inside the slit 25 of the first link member 21 along the longitudinal direction of the slit 25.

When the first link member 21 is in a position close to the cam shaft 231, the first intermediate transfer roller 64a provided on the another end of the first swing member 24a is, as shown in FIG. 7, lifted upward with the first swing member 24a by the biasing force from the elastic member. At this time, the projection 234a is positioned at the upper end of the slit 25, or in other words, at the end on the side that is away from the photoreceptor drum 3a. In this way, when the intermediate transfer rollers 64 are in a position separated from the photoreceptor drum 3a, the intermediate transfer belt 61 is also in a position separated from the photoreceptor drum 3a.

On the other hand, when the first link member 21 moves to a position that is more separated than the position near the cam shaft 231, as shown in FIG. 8, the first swing member 24a is lowered against the biasing force from the elastic member, and the first intermediate transfer roller 64a moves to the pressing position. As a result, the intermediate transfer belt 61 is capable of making pressing contact with the photoreceptor drum 3a.

Similarly, when the second link member 22 is in a position near the cam shaft 231, each of the second intermediate transfer roller 64b to fourth intermediate transfer roller 64d move to the separated position. On the other hand, when the second link member 22 moves to a position that is more separated than the position near the cam shaft 231, each of the second intermediate transfer roller 64b to fourth intermediate transfer roller 64d are lowered and move to the pressing position. As a result, the intermediate transfer belt 61 is capable of making pressing contact with the photoreceptor drums 3b to 3d.

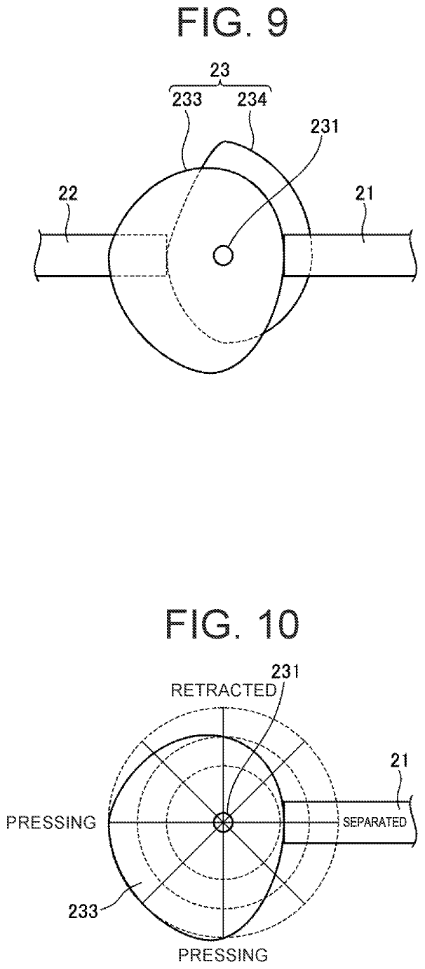

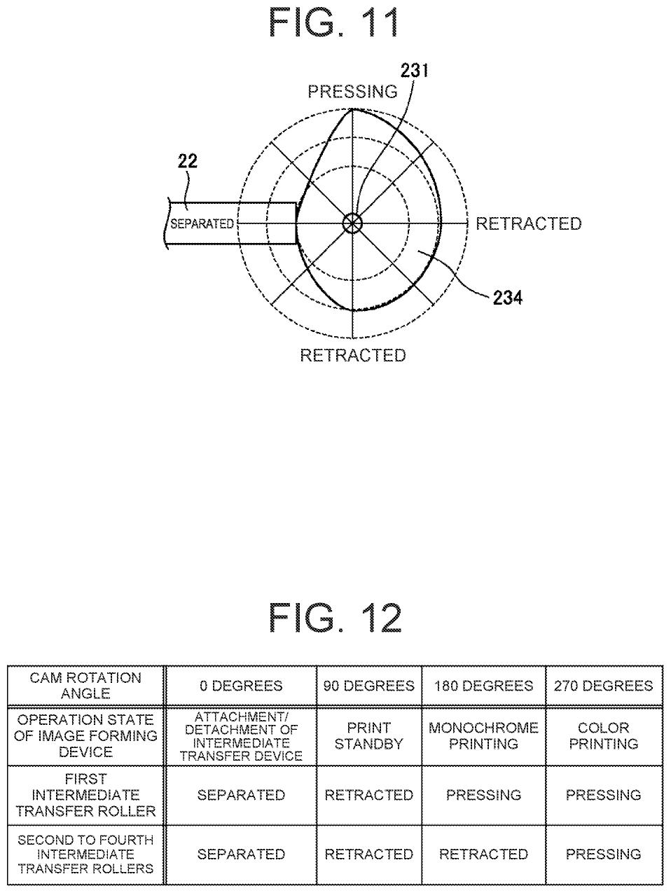

Next, the cam 23 will be described in more detail with reference to FIGS. 9 to 11. FIG. 9 is a diagram showing an example of the configuration of the cam 23 included in the intermediate transfer belt unit 6 according to the embodiment of the present disclosure. FIG. 10 is a diagram showing an example of the first cam 233 of the cam 23 shown in FIG. 9. Furthermore, FIG. 11 is a diagram showing an example of the second cam 234 of the cam 23 shown in FIG. 9.

As shown in FIG. 9, the first cam 233 and the second cam 234 are fixed to the cam shaft 231 in positions that are offset in the front-rear direction of the intermediate transfer belt unit 6, and rotate around the cam shaft 231. The first link member 21 makes contact with the outer periphery of the first cam 233. The second link member 22 makes contact with the outer periphery of the second cam 234.

For example, in the intermediate transfer belt unit 6, when the first intermediate transfer roller 64a is in the separated position, as shown in FIG. 10, the first link member 21 is disposed so as to make contact with a peripheral edge that minimizes the distance from the center of the first cam 233 (cam shaft 231) to the outer periphery. Furthermore, when the first intermediate transfer roller 64a is in the pressing position, as shown in FIG. 10, the first link member 21 is disposed so as to make contact with a peripheral edge that maximizes the distance from the center of the first cam 233 (cam shaft 231) to the outer periphery. Moreover, when the first intermediate transfer roller 64a is in the retracted position, as shown in FIG. 10, the first link member 21 is disposed so as to make contact with a peripheral edge such that the distance from the center of the first cam 233 to the outer periphery is between the distance when the first intermediate transfer roller 64a is in the separated position and the distance when the first intermediate transfer roller 64a is in the pressing position.

In addition, as shown in FIG. 11, when each of the second intermediate transfer roller 64b to fourth intermediate transfer roller 64d are in the separated position, the second link member 22 is disposed so as to make contact with a peripheral edge that minimizes the distance from the center of the second cam 234 (cam shaft 231) to the outer periphery. Also, when each of the second intermediate transfer roller 64b to fourth intermediate transfer roller 64d are in the pressing position, as shown in FIG. 11, the second link member 22 is disposed so as to make contact with a peripheral edge that maximizes the distance from the center of the second cam 234 (cam shaft 231) to the outer periphery. Moreover, when each of the second intermediate transfer roller 64b to fourth intermediate transfer roller 64d are in the retracted position, as shown in FIG. 11, the second link member 22 is disposed so as to make contact with a peripheral edge such that the distance from the center of the second cam 234 to the outer periphery is between the distance when each of the second intermediate transfer roller 64b to fourth intermediate transfer roller 64d are in the separated position and the distance when the second intermediate transfer roller 64b to fourth intermediate transfer roller 64d are in the pressing position.

For example, the positions of the first cam 233 and the second cam 234 when the first intermediate transfer roller 64a is in the separated position, and each of the second intermediate transfer roller 64b to fourth intermediate transfer roller 64d are in the separated position is assumed to be the initial position. From the initial position, when the first cam 233 and the second cam 234 are rotated clockwise 90 degrees at a time, the position of each of the first intermediate transfer roller 64a to fourth intermediate transfer roller 64d and the state of the image forming device 100 have the relationship shown in the table in FIG. 12. FIG. 12 is a table showing a correspondence relationship between the rotation angle of the cam 23 included in the intermediate transfer belt unit 6 according to the embodiment of the present disclosure, the operation state of the image forming device 100, the position of the first intermediate transfer roller 64a, and the position of the second intermediate transfer roller 64b to fourth intermediate transfer roller 64d. Note that the rotation angle of the cam 23 here is the rotation angle of the first cam 233 and the second cam 234.

That is, as shown in FIG. 12, when the cam 23 is in the initial position, or in other words, when the rotation angle of the cam 23 is 0 degrees, the first intermediate transfer roller 64a and each of the second intermediate transfer roller 64b to fourth intermediate transfer roller 64d are positioned in the separated position. At this time, the operation state of the image forming device 100 is detachment of the intermediate transfer belt unit 6.

When the cam 23 rotates 90 degrees from the initial position, the first intermediate transfer roller 64a and each of the second intermediate transfer roller 64b to fourth intermediate transfer roller 64d are positioned in the retracted position. At this time, the operation state of the image forming device 100 is print standby.

When the cam 23 rotates 180 degrees from the initial position, the first intermediate transfer roller 64a is positioned in the pressing position, and each of the second intermediate transfer roller 64b to fourth intermediate transfer roller 64d are positioned in the retracted position. At this time, the operation state of the image forming device 100 is monochrome printing.

Furthermore, when the cam 23 rotates 270 degrees from the initial position, the first intermediate transfer roller 64a and the second intermediate transfer roller 64b to fourth intermediate transfer roller 64d are positioned in the pressing position. At this time, the operation state of the image forming device 100 is color printing.

As described above, the intermediate transfer belt unit 6 is capable of switching the positions of the first intermediate transfer roller 64a to fourth intermediate transfer roller 64d between the separated position, the retracted position, and the pressing position by changing the rotation angle of the cam 23 according to the operation state of the image forming device 100. In particular, when the image forming device 100 is in print standby, it is possible to position the first intermediate transfer roller 64a to fourth intermediate transfer roller 64d in the retracted position. As a result, it is possible to suppress the impact noise generated when the operation state of the image forming device 100 transitions from print standby to monochrome printing or color printing, and the photoreceptor drums 3a to 3d are pressed by the first intermediate transfer roller 64a to fourth intermediate transfer roller 64d.

### Modification

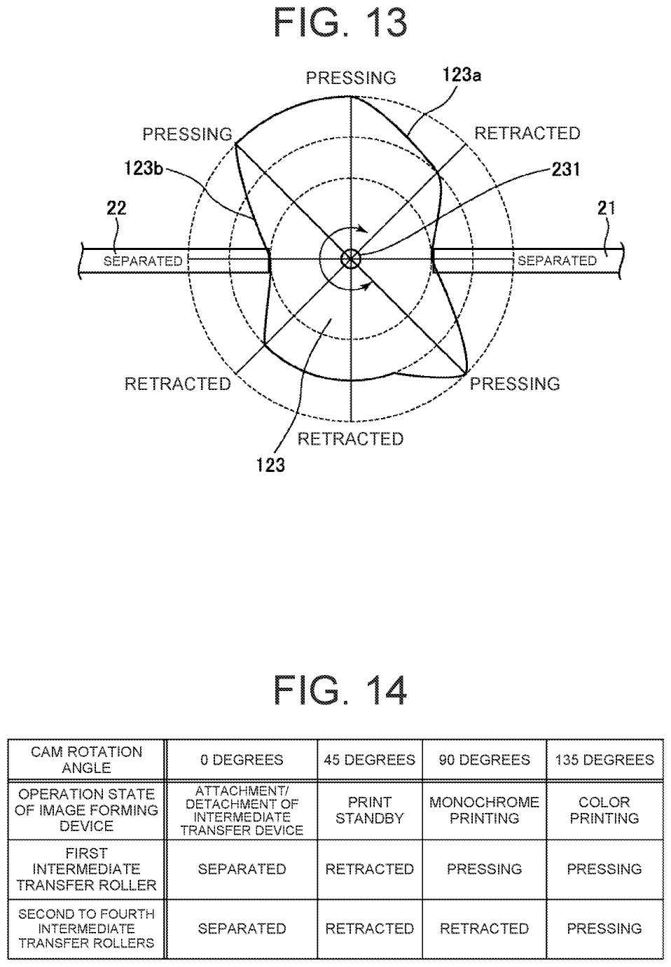

Next, the intermediate transfer belt unit 6 according to a modification of the embodiment of the present disclosure will be described with reference to FIGS. 13 and 14. FIG. 13 is a diagram showing an example of a cam 123 included in the intermediate transfer belt unit 6 according to the modification of the embodiment of the present disclosure. FIG. 14 is a table showing a correspondence relationship between the rotation angle of the cam 123 included in the intermediate transfer belt unit 6 according to the modification of the embodiment of the present disclosure, the operation state of the image forming device 100, the position of the first intermediate transfer roller 64a, and the position of the second intermediate transfer roller 64b to fourth intermediate transfer roller 64d.

The cam 23 provided in the intermediate transfer belt unit 6 according to the embodiment of the present disclosure is constituted by two flat cams, namely the first cam 233 and the second cam 234 as described above. In contrast, the intermediate transfer belt unit 6 according to the modification of the embodiment of the present disclosure differs in that it includes a cam 123 constituted by a single flat cam instead of the cam 23. The intermediate transfer belt unit 6 according to the modification of the embodiment of the present disclosure has the same configuration as the intermediate transfer belt unit 6 according to the embodiment except in that the cam 123 is provided instead of the cam 23. Therefore, the same members are denoted by the same reference numerals, and the descriptions will be omitted.

As shown in FIG. 13, the outer periphery of the cam 123 includes a first peripheral edge 123a, which is a right half outer edge, and a second peripheral edge 123b, which is the left half outer edge with respect to a straight line that vertically intersects the cam shaft 231 in the up-down direction.

In the cam 123, the distance between the first link member 21 and the cam shaft 231 changes according to the shape of the first peripheral edge 123a as the cam 123 rotates. In this way, the position of the first intermediate transfer roller 64a can be switched according to the change in the distance between the first link member 21 and the cam shaft 231.

That is, when the distance between the cam shaft 231 and the contact position between first link member 21 and the first peripheral edge 123a is a smallest first distance, the first intermediate transfer roller 64a is in the separated position. When the distance between the cam shaft 231 and the contact position between first link member 21 and the first peripheral edge 123a is a largest second distance, the first intermediate transfer roller 64a is in the pressing position. Furthermore, when the distance between the cam shaft 231 and the contact position between first link member 21 and the first peripheral edge 123a is longer than the first distance mentioned above, but shorter than the second distance, the first intermediate transfer roller 64a is in the retracted position.

Moreover, in the cam 123, the distance between the second link member 22 and the cam shaft 231 changes according to the shape of the second peripheral edge 123b as the cam 123 rotates. In this way, the positions of the second intermediate transfer roller 64b to fourth intermediate transfer roller 64d can be switched according to the change in the distance between the second link member 22 and the cam shaft 231.

That is, when the distance between the cam shaft 231 and the contact position between second link member 22 and the second peripheral edge 123b is a smallest third distance, the second intermediate transfer roller 64b to fourth intermediate transfer roller 64d are in the separated position. When the distance between the cam shaft 231 and the contact position between second link member 22 and the second peripheral edge 123b is a largest fourth distance, the second intermediate transfer roller 64b to fourth intermediate transfer roller 64d are in the pressing position. Furthermore, when the distance between the cam shaft 231 and the contact position between second link member 22 and the second peripheral edge 123b is longer than the third distance mentioned above, but shorter than the fourth distance, the second intermediate transfer roller 64b to fourth intermediate transfer roller 64d are in the retracted position.

Here, a state where the first intermediate transfer roller 64a and each of the second intermediate transfer roller 64b to fourth intermediate transfer roller 64d are in the separated position is assumed to be the initial position. When the cam 123 rotates clockwise from the initial position, as shown in FIG. 14, the positions of each of the first intermediate transfer roller 64a to fourth intermediate transfer roller 64d are switched.

Specifically, when the cam 123 is in the initial position, or in other words, when the rotation angle of the cam 123 is 0 degrees, the first intermediate transfer roller 64a and each of the second intermediate transfer roller 64b to fourth intermediate transfer roller 64d are positioned in the separated position. At this time, the operation state of the image forming device 100 is detachment of the intermediate transfer belt unit 6.

When the cam 123 rotates 45 degrees from the initial position, the first intermediate transfer roller 64a and each of the second intermediate transfer roller 64b to fourth intermediate transfer roller 64d are positioned in the retracted position. At this time, the operation state of the image forming device 100 is print standby.

When the cam 123 rotates 90 degrees from the initial position, the first intermediate transfer roller 64a is positioned in the pressing position, and each of the second intermediate transfer roller 64b to fourth intermediate transfer roller 64d are positioned in the retracted position. At this time, the operation state of the image forming device 100 is monochrome printing.

Furthermore, when the cam 123 rotates 135 degrees from the initial position, the first intermediate transfer roller 64a and the second intermediate transfer roller 64b to fourth intermediate transfer roller 64d are positioned in the pressing position. At this time, the operation state of the image forming device 100 is color printing.

Note that the intermediate transfer belt unit 6 according to the modification of the embodiment has a configuration in which the position of the first intermediate transfer roller 64a is switched by the position of the first peripheral edge 123a according to the rotation angle of the cam 123, and the positions of the second intermediate transfer roller 64b to fourth intermediate transfer roller 64d are switched by the position of the second peripheral edge 123b. As a result, the rotation direction of the cam 123 is configured to be reversed when rotated by 135 degrees from the initial position.

As described above, because the intermediate transfer belt unit 6 according to the modification of the embodiment includes the cam 123, the number of components constituting the cam can be reduced compared to the intermediate transfer belt unit 6 according to the embodiment. However, the intermediate transfer belt unit 6 according to the embodiment has a larger rotation angle for switching the position of the intermediate transfer rollers 64 than the intermediate transfer belt unit 6 according to the modification of the embodiment, and the rotation angle is also a single direction. As a result, a switching control of the positions of the intermediate transfer rollers 64 can be more easily performed in the intermediate transfer belt unit 6 according to the embodiment than the intermediate transfer belt unit 6 according to the modification of the embodiment.

The image forming device 100 includes an operation button (not shown), and a configuration is possible in which a detachment instruction of the intermediate transfer belt unit 6 is received by the operation button. In such a configuration, in the intermediate transfer belt unit 6, the movement mechanism 20 moves the positions of the first intermediate transfer roller 64a to fourth intermediate transfer roller 64d to the separated position only when a detachment instruction is received. Further, when a detachment instruction is not received, a configuration is possible in which the movement mechanism 20 switches the positions of the first intermediate transfer roller 64a to fourth intermediate transfer roller 64d to either the retracted position or the pressing position according to the operation state of the image forming device 100.

In this way, when a detachment instruction is not received, the movement mechanism 20 controls the positions of the first intermediate transfer roller 64a to fourth intermediate transfer roller 64d so as to switch to either the retracted position or the pressing position. Therefore, the switching control of the positions becomes easier.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming device comprising:
one or more image carriers on which a toner image is formed;
a transfer belt that transfers a toner image formed on the image carrier;
a presser that presses the transfer belt against the image carrier to transfer the toner image onto the transfer belt; and
a switching mechanism that switches a position of the presser according to a rotation angle of a cam; wherein
the switching mechanism switches a position of the presser to one of a first position that presses the transfer belt against the image carrier, a second position that is separated from the image carrier, and a third position that is a position separated from the image carrier and having a smaller separation distance from the image carrier than the second position.

2. The image forming device according to claim 1, wherein
the switching mechanism, when setting a position of the presser to the first position, switches the presser from the third position to the first position.

3. The image forming device according to claim 1, wherein
the second position is a position of the presser when the presser is detached from the image forming device.

4. The image forming device according to claim 1, wherein
the third position is a position of the presser when the image forming device is in print standby.

5. The image forming device according to claim 1, comprising:
a plurality of the image carriers including a first image carrier on which the toner image is formed during monochrome printing; and
a plurality of the pressers including a first presser that presses the first image carrier; wherein
the switching mechanism, during the monochrome printing, switches a position of the first presser to the first position, and also switches, among the plurality of pressers, a position of each of the remaining pressers excluding the first presser to the third position.

6. The image forming device according to claim 5, wherein
the cam includes a first cam and a second cam that rotate by the same rotating shaft, and
the switching mechanism switches a position of the first presser according to a rotation angle of the first cam, and also switches a position of each of the remaining pressers according to a rotation angle of the second cam.

7. The image forming device according to claim 5, wherein
an outer periphery of the cam includes a first peripheral edge and a second peripheral edge, and
the switching mechanism switches a position of the first presser based on a position of the first peripheral edge according to a rotation angle of the cam, and also switches a position of each of the remaining pressers based on a position of the second peripheral edge according to the rotation angle of the cam.
